(19) United States
(12) Patent Application Publication
(10) Pub. No.: US 2025/0111471 A1
(43) Pub. Date: Apr. 3, 2025

(54) TECHNIQUES FOR PRESENTING MAGNIFIED VIEWS IN AN EXTENDED REALITY ENVIRONMENT

(71) Applicant: Apple Inc., Cupertino, CA (US)

(72) Inventors: Elena J. Nattinger, Menlo Park, CA (US); Michael J. Rockwell, Palo Alto, CA (US); Christopher I. Word, San Francisco, CA (US); Devin W. Chalmers, Oakland, CA (US); Paulo R. Jansen dos Reis, San Jose, CA (US); Paul Ewers, San Jose, CA (US); Peter Burgner, Venice, CA (US); Anna L. Brewer, Santa Barbara, CA (US); Jeffrey S. Norris, Saratoga, CA (US); Allison W. Dryer, Tiburon, CA (US); Andrew Muehlhausen, Seattle, WA (US); Luis R. Deliz Centeno, Fremont, CA (US); Thomas J. Moore, Northglenn, CO (US); Alesha Unpingco, Milpitas, CA (US); Thomas G. Salter, San Francisco, CA (US)

(21) Appl. No.: 18/825,453

(22) Filed: Sep. 5, 2024

Related U.S. Application Data
(60) Provisional application No. 63/541,284, filed on Sep. 28, 2023.

(51) Int. Cl. G06T 3/40; G06F 3/01

(52) U.S. Cl. CPC G06T 3/40; G06F 3/013

(57) ABSTRACT

Embodiments disclosed herein are directed to devices, systems, and methods for presenting a magnified view in an extended reality environment. Specifically, a magnified view includes a zoom reticle that is presented at a display location of a display. The zoom reticle includes magnified content that includes a magnified portion of a user's field of view. For example, the magnified content may be generated from image data selected from a corresponding portion of a field of view of a camera. The position of the zoom reticle on the display, as well as the portion of the field of view that is magnified, may vary in different circumstances such as described herein.

### CROSS-REFERENCE TO RELATED APPLICATIONS

This application claims the benefit under 35 U.S.C. § 119 (e) of U.S. Provisional Patent Application No. 63/541,284, filed Sep. 28, 2023, the contents of which are incorporated herein by reference as if fully disclosed herein.

### FIELD

The described embodiments relate generally to presenting magnified views in an extended reality environment.

### BACKGROUND

Extended reality systems can be used to generate partially or wholly simulated environments (e.g., virtual reality environments, mixed reality environments, or the like) in which virtual content can replace or augment the physical world. The simulated environments may provide engaging experiences for a user, and are used in gaming, personal communication, virtual travel, healthcare, and many other contexts. In some instances, the simulated environment may include information captured from the user's environment. This may provide a user with additional ways to interact with or learn more about their surrounding environment. Accordingly, it may be desirable for an extended reality system to provide a user experience that facilitates such user interaction.

### SUMMARY

Embodiments described herein are directed to systems, devices, and methods for presenting a magnified view in an extended reality environment. Some embodiments are directed to a method of operating an electronic device that includes selecting a display location of a display of the electronic device. A region of a field of view of a camera of the electronic device is selected, and text is detected in the region. In response to detecting the text, an image modification technique is selected. A zoom reticle is displayed at the display location, wherein the zoom reticle includes a magnified portion of the region that is modified according to the selected image modification technique.

Other embodiments are directed to an electronic device including a camera having a field of view and a display. The electronic device includes a processor operably coupled to the camera and the display, such that the processor is configured to select a display location of the display and select a region of a field of view of a camera of the electronic device. The processor may detect text in the region and, in response to detecting the text, select an image modification technique. The processor may display a zoom reticle at the display location, wherein the zoom reticle includes a magnified portion of the region that is modified according to the selected image modification technique.

Additionally, some embodiments are directed to a method of operating an electronic device that includes receiving a request to activate a zoom reticle. In response to the request, a display location of a display of the electronic device and a region of a field of view of a camera of the electronic device are selected. A content type associated with the region is determined, and a set of display properties is selected based on the determined content type. A zoom reticle is displayed at the display location, wherein the zoom reticle includes a magnified portion of the region that is displayed according to the selected set of display properties.

Still other embodiments are directed to an electronic device including a camera having a field of view and a display. The electronic device includes a processor operably coupled to the camera and the display, such that the processor is configured to select a display location of the display and select a region of a field of view of a camera of the electronic device. The processor may determine a content type associated with the region, and select a set of display properties based on the determined content type. The processor may display a zoom reticle at the display location, wherein the zoom reticle includes a magnified portion of the region that is displayed according to the selected set of display properties.

Some embodiments are directed to a method of operating an electronic device that includes receiving a request to activate a zoom reticle. In response to the request, a display location of a display of the electronic device is selected. Text is detected in a region of a field of view of a camera of the electronic device, and a magnification level is selected based on the detected text. A zoom reticle is displayed at the display location, wherein the zoom reticle includes a portion of the region that is magnified according to the magnification level.

Additional embodiments are directed to a method of operating an electronic device that includes collecting, during a first period of time, location information of a gaze of a user within a first region of a gaze field of view. Movement of the gaze of the user to a second region of the gaze field of view is detected during a second period of time subsequent to the first period of time. In response to detecting the movement of the gaze of the user to the second region, a display location of a display of the electronic device is selected using the location information collected during the first period of time. A zoom reticle is displayed at the display location, wherein the zoom reticle includes a magnified portion of the gaze field of view.

Some embodiments are directed to an electronic device including a device and an eye tracker configured to detect a gaze of a user within a gaze field of view. The electronic device includes a processor operably coupled to the camera and the display, such that the processor is configured to collect, during a first period of time, location information of a gaze of a user within a first region of a gaze field of view. The processor may detect, during a second period of time subsequent to the first period of time, movement of the gaze of the user to a second region of the gaze field of view. In response to detecting the movement of the gaze of the user to the second region, the processor may select a display location of a display of the electronic device, wherein the display location is selected using the location information collected during the first period of time. The processor may display a zoom reticle at the display location, wherein the zoom reticle includes a magnified portion of the gaze field of view.

Still other embodiments are directed to a method of operating an electronic device that includes collecting, during a first period of time, location information of a gaze of a user within a gaze field of view. A request to activate a zoom reticle is received, wherein the request has a request type. In response to receiving the request, an analysis technique is selected based on the request type and a display location of a display of the electronic device is selected. The display location is selected based on an analysis of the collected information using the selected analysis technique. A zoom reticle is displayed at the selected display location, wherein the zoom reticle includes a magnified portion of the gaze field of view.

Some embodiments are directed to a method of operating an electronic device that includes receiving a request requiring a target input in a field of view of a camera of the electronic device. A zoom reticle is displayed at a display of the electronic device, wherein the zoom reticle includes a magnified portion of the field of view of the camera of the electronic device. The target input is determined using the magnified portion of the field of view, and the request is performed with respect to the target input.

Other embodiments are directed to an electronic device including a camera having a field of view and a display. The electronic device includes a processor operably coupled to the camera and the display, such that the processor is configured to receive a request requiring a target input in a field of view of a camera of the electronic device. The processor may display a zoom reticle at a display of the electronic device, wherein the zoom reticle includes a magnified portion of the field of view of the camera of the electronic device. The processor determines the target input using the magnified portion of the field of view, and may perform the request with respect to the target input

In addition to the example aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a block diagram of an example electronic device that may be used in the extended reality systems described herein.

FIGS. 2A and 2B depict diagrams illustrating portions of a physical environment from the perspective of the electronic device, such as described herein.

FIG. 3A depict a front view of a scene in which a magnified view may be displayed by an electronic device as described herein. FIG. 3B depicts a front view of the scene of FIG. 3A, in which a zoom reticle is displayed.

FIG. 4 depicts a method of selecting an initial display location of a zoom reticle based on the type of request that is used to activate the zoom reticle.

FIG. 5 depicts a method of selecting an initial display location of a zoom reticle when a user's gaze is used to request the activation of the zoom reticle.

FIGS. 6A-6D depict front views of the scene of FIG. 3A, and illustrate how a zoom reticle may be positioned within the scene.

FIG. 7 depicts a method of displaying a zoom reticle that includes magnified content, where the magnified content is presented according to a selected set of display parameters.

FIG. 8 depicts a method of displaying a zoom reticle that includes magnified content, wherein the magnified content includes text that is modified according to an image modification technique.

FIGS. 9A and 9B depict front views of the scene of FIG. 3A, and illustrate how a zoom reticle may present magnified content that includes text.

FIG. 10 depicts a method of using a magnified view to select a target input associated with a request.

FIG. 11 depicts a front view of the scene of FIG. 3A, and illustrates how a zoom reticle may be used to select a target input.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments disclosed herein are directed to devices, systems, and methods for presenting a magnified view in an extended reality environment. Specifically, a magnified view includes a zoom reticle that is presented at a display location of a display. The zoom reticle includes magnified content that includes a magnified portion of a user's field of view. For example, the magnified content may be generated from image data selected from a corresponding portion of a field of view of a camera. The position of the zoom reticle on the display, as well as the portion of the field of view that is magnified, may vary in different circumstances such as described herein.

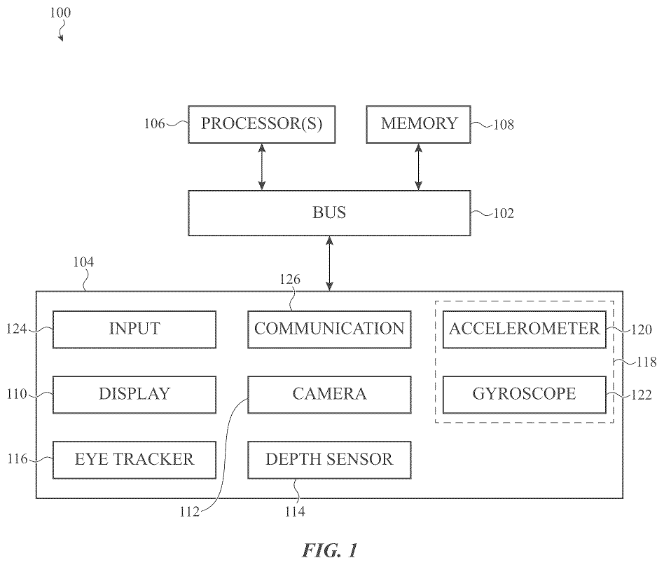

These and other embodiments are discussed below with reference to FIGS. 1-11. However, those skilled in the art will readily appreciate that the detailed description given herein with respect to these figures is for explanatory purposes only and should not be construed as limiting.

The devices and methods described herein may be utilized as part of an extended reality system in which an extended reality environment is generated and displayed to a user. Various terms are used herein to describe the various extended reality systems and associated extended reality environments described herein. For example, as used herein, a “physical environment” is a portion of the physical world/real world around a user that the user may perceive and interact with without the aid of the extended reality systems described herein. For example, a physical environment may include a room of a building or an outdoor space, as well as any people, animals, or objects (collectively referred to herein as “real-world objects”) in that space, such as plants, furniture, books, or the like.

As used herein, an “extended reality environment” refers to a wholly or partially simulated environment that a user may perceive and/or interact with using an extended reality system as described herein. In some instances, an extended reality environment may be a virtual reality environment, which refers to a wholly simulated environment in which the user's physical environment is completely replaced with virtual content within the virtual reality environment. The virtual reality environment may not be dependent on the user's physical environment, and thus may allow the user to perceive that they are in a different, simulated location (e.g., standing at a beach when they are actually standing in a room of a building). The virtual reality environment may include virtual objects (e.g., simulated objects that may be perceived by the user but are not actually present in the physical environment) with which the user may interact.

In other instances, an extended reality environment may be a mixed reality environment, a wholly or partially simulated environment in which virtual content may be presented along with a portion of a user's physical environment. Specifically, a mixed reality environment may include a reproduction (including a direct reproduction and/or an indirect reproduction) and/or a modified representation of one or more portions of the user's physical environment surrounding the extended reality system. In this way, the user may be able to perceive (directly or indirectly) a portion of their physical environment through the mixed reality environment while also still perceiving the virtual content.

As used herein, a “reproduction” of a portion of a physical environment refers to a portion of an extended reality environment that recreates that portion of the physical environment within the extended reality environment. For example, the extended reality system may, such as in the case of augmented reality systems, have a transparent or translucent display and may be configured to present virtual content on the transparent or translucent display (or displays) to create the extended reality environment. In these embodiments, the user may directly view, through the transparent or translucent display (or displays), portions of the physical environment that are not obscured by the presented virtual content. Accordingly, these portions of the physical environment directly viewable by the user would be considered reproductions for the purposes of this application, and are referred to herein as “direct reproductions.”

In other embodiments, the extended reality system includes an opaque display (or displays), such that a user is unable to directly view the physical environment through the display. In these embodiments, the extended reality system may include one or more cameras that are able to capture images of the physical environment. The extended reality system may present a portion of these images to a user by displaying them via an opaque display, such that the user indirectly views the physical environment via the displayed images. The images (or portions thereof), when presented to a user as part of an extended reality environment, are considered reproductions (also referred to herein as “indirect reproductions”) for the purposes of this application.

It should be appreciated that images captured of the physical environment that are used to generate indirect reproductions may undergo standard image processing operations such as tone mapping, color balancing, and/or image sharpening, in an effort to match the indirect reproduction to the physical environment. Additionally, in some instances the extended reality environment is displayed using foveated rendering, in which different portions of the extended reality environment are rendered using different levels of fidelity (e.g., image resolution) depending on a direction of a user's gaze. In these instances, portions of a reproduction that are rendered at lower fidelity using these foveated rendering techniques are still considered reproductions for the purposes of this application.

As used herein, a “modified representation” of a portion of a physical environment refers to a portion of an extended reality environment that is derived from the physical environment, but intentionally obscures one or more aspects of the physical environment. Whereas an indirect reproduction attempts to replicate a portion of the user's physical environment within the extended reality environment, a modified representation intentionally alters one or more visual aspects of a portion of the user's physical environment (e.g., using one or more visual effects such as an artificial blur). In this way, a modified representation of a portion of a user's physical environment may allow a user to perceive certain aspects of that portion of the physical environment while obscuring other aspects. In the example of an artificial blur, a user may still be able to perceive the general shape and placement of real-world objects within the modified representation, but may not be able to perceive the visual details of these objects that would otherwise be visible in the physical environment. In instances where the extended reality environment is displayed using foveated rendering, portions of a modified representation that are in peripheral regions of the extended reality environment (relative to the user's gaze) may be rendered at lower fidelity using foveated rendering techniques.

Reproductions and/or modified representations of a user's physical environment may be used in a variety of extended reality environments. For example, an extended reality system may be configured to operate in a “passthrough” mode, during which the extended reality system generates and presents an extended reality environment that includes a reproduction of a portion of the user's physical environment. This allows the user to indirectly view a portion of their physical environment, even if one or more components of the extended reality system (e.g., a display) may interfere with the user's ability to directly view the same portion of their physical environment. When an extended reality system is operating in a passthrough mode, some or all of the extended reality environment that is displayed to the user may include a reproduction of the user's physical environment. In some instances, one or more portions of the extended reality environment may include virtual content and/or modified representations of the user's physical environment, in addition to the reproduction of the user's physical environment. Additionally or alternatively, virtual content (e.g., graphical elements of a graphical user interface, virtual objects) may be overlaid over portions of the reproduction. In this way, a user may be able to simultaneously perceive virtual content and their physical environment.

Generally, the extended reality systems described herein include an electronic device that is capable of capturing and displaying images to a user as part of an extended reality environment. FIG. 1 depicts a block diagram of an example electronic device 100 that may be part of an extended reality system as described herein. The electronic device 100 may be configured to capture, process, and display images as part of an extended reality environment. In some implementations, the electronic device 100 is a handheld electronic device (e.g., a smartphone or a tablet) configured to present an extended reality environment to a user. In some of these implementations, the handheld electronic device may be temporarily attached to an accessory that allows the handheld electronic device to be worn by a user. In other implements, the electronic device 100 is a head-mounted device (HMD) that a user wears.

In some embodiments, the electronic device 100 has a bus 102 that operatively couples an I/O section 104 with one or more computer processors 106 and memory 108, and includes circuitry that interconnects and controls communications between components of the electronic device 100. I/O section 104 includes various system components that may assist with the operation of the electronic device 100. The electronic device 100 includes a set of displays 110 and a set of cameras 112. The set of cameras 112 may capture images of the user's physical environment (e.g., a scene), and may use these images in generating an extended reality environment (e.g., as part of a passthrough mode) that may include the magnified views as described herein. The set of displays 110 may display the extended reality environment such that the user may view it, thereby allowing the user to perceive their physical environment via the electronic device 100. The set of displays 110 may include a single display, or may include multiple displays (e.g., one display for each eye of a user). Each display of the set of displays may utilize any suitable display technology, and may include, for example, a liquid-crystal display (LCD), an organic light emitting diode (OLED) display, a light emitting diode (LED) display, a quantum dot light emitting diode (QLED) display, or the like.

For the purpose of discussion, the techniques used to present a magnified view are discussed herein with respect to a single display. It should be appreciated, however, that the same techniques may be extended to additional displays of an extended reality system. For example, if an electronic device 100 includes multiple displays (e.g., a first display and a second display), a zoom reticle may be displayed on each display. In this way, a first zoom reticle may be displayed on the first display as part of an extended reality environment, such that it may be viewed by a first eye of a user (e.g., when the electronic device 100 is worn on or otherwise held near the head of the user). Similarly, a second zoom reticle may be displayed on a second display as part of the extended reality environment, such that it may be viewed by a second eye of the user. The first and second zoom reticles may be displayed at different respective positions on the first and second displays, which may collectively allow the user to perceive a single zoom reticle as if it is positioned at a particular location within the extended reality environment. For example, these relative positions may be selected to make the zoom reticle appear as if it is positioned at a particular distance from the user.

Additionally, the techniques regarding presenting a magnified view are discussed with respect to a single camera, however it should be appreciated that the same techniques may utilize multiple cameras. For example, in instances where a magnified portion of a field of view (e.g., the field of view of a camera) is presented in a zoom reticle, this magnified portion may be generated using image data from a single camera or multiple cameras (e.g., by fusing images captured from multiple cameras). Similarly, in an instance where zoom reticles are displayed on multiple displays, each zoom reticle may include magnified image data captured from different cameras (or groups of cameras). For example, a first zoom reticle displayed on a first display may include a corresponding magnified portion generated from a first camera (or group of cameras), while a second zoom reticle displayed on a second display may include a magnified portion generated from a different camera (e.g., a second camera or group of cameras).

The memory 108 of the electronic device 100 can include one or more non-transitory computer-readable storage devices. These non-transitory computer-readable storage devices may be used to store computer-executable instructions, which, when executed by one or more computer processors 106, can cause the computer processors to perform the processes that are described herein (the various techniques used to present a magnified view as described herein). Additionally, non-transitory computer-readable storage devices may be used to store images captured as part of a media capture event as described herein.

A computer-readable storage device can be any medium that can tangibly contain or store computer-executable instructions for use by or in connection with an instruction execution system, apparatus, or device (e.g., the one or more processors 106). In some examples, the storage device is a transitory computer-readable storage medium. In some examples, the storage device is a non-transitory computer-readable storage medium. The non-transitory computer-readable storage device can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The one or more computer processors 106 can include, for example, a processor, a microprocessor, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute an operating system and applications of the electronic device 100, as well as to facilitate presenting a magnified view within an extended reality environment as described herein. Accordingly, any of the processes described herein may be stored as instructions on a non-transitory computer-readable storage device, such that a processor may utilize these instructions to perform the various blocks of the processes described herein. Similarly, the devices described herein include a memory (e.g., memory 108) and one or more processors (e.g., processor 106) operatively coupled to the memory. The one or more processors may receive instructions from the memory and are configured to execute these instructions to perform the various blocks of the processes described herein. Any of the processes described herein may be performed, using the devices described herein, as a method of presenting a magnified view in an extended reality environment.

In some implementations, the electronic device 100 includes a set of depth sensors 114 (which may include a single depth sensor or multiple depth sensors), each of which is configured to calculate depth information for a portion of the environment in front of the electronic device 100. Specifically, each of the set of depth sensors 114 may calculate depth information within a field of coverage (e.g., the widest lateral extent to which that depth sensor is capable of providing depth information). In some instances, the field of coverage of one of the set of depth sensors 114 may at least partially overlap a field of view (e.g., the spatial extent of a scene that a camera is able to capture using an image sensor of the camera) of at least one of the set of cameras 112, thereby allowing the depth sensor to calculate depth information associated with the field of view(s) of the set of cameras 112.

Information from the depth sensors may be used to calculate the distance between the depth sensor and various points in the environment around the electronic device 100. In some instances, depth information from the set of depth sensors 114 may be used to generate a depth map as described herein. The depth information may be calculated in any suitable manner. In one non-limiting example, a depth sensor may utilize stereo imaging, in which two images are taken from different positions, and the distance (disparity) between corresponding pixels in the two images may be used to calculate depth information. In another example, a depth sensor may utilize structured light imaging, whereby the depth sensor may image a scene while projecting a known illumination pattern (typically using infrared illumination) toward the scene, and then may look at how the pattern is distorted by the scene to calculate depth information. In still another example, a depth sensor may utilize time of flight sensing, which calculates depth based on the amount of time it takes for light (typically infrared) emitted from the depth sensor to return from the scene. A time-of-flight depth sensor may utilize direct time of flight or indirect time of flight, and may illuminate an entire field of coverage at one time or may only illuminate a subset of the field of coverage at a given time (e.g., via one or more spots, stripes, or other patterns that may either be fixed or may be scanned across the field of coverage). In instances where a depth sensor utilizes infrared illumination, this infrared illumination may be utilized in a range of ambient conditions without being perceived by a user.

In some implementations, the electronic device 100 includes an eye tracker 116. The eye tracker 116 may be configured to determine the position of a user's eyes relative to the electronic device 100 (or a particular component thereof). The eye tracker 116 may include any suitable hardware for identifying and locating the eyes of a user, such as one or more cameras, depth sensors, combinations thereof or the like. In some instances, the eye tracker 116 may also be configured to detect a location/direction of a user's gaze. It should be appreciated that eye tracker 116 may include a single module that is configured to determine the position of both of a user's eyes, or may include multiple units, each of which is configured to determine the position of a corresponding eye of the user.

Additionally or alternatively, the electronic device 100 may include a set of sensors 118 that are capable of determining motion and/or orientation of the electronic device 100 (or particular components thereof). For example, the set of sensors 118 shown in FIG. 1 include an accelerometer 120 and a gyroscope 122. Information from the set of sensors 118 may be used to calculate pose information for the electronic device 100 (or particular components thereof). This may allow the electronic device 100 to track its position and orientation as the electronic device 100 is moved. Additionally or alternatively, information captured by the set of cameras 112 and/or the set of depth sensors 114 may be used to calculate pose information for the electronic device 100 (or particular components thereof), for example by using simultaneous localization and mapping (SLAM) techniques.

In addition, the electronic device 100 can include a set of input mechanisms 124 that a user may manipulate to interact with and provide inputs to the extended reality system (e.g., a touch screen, a softkey, a keyboard, a virtual keyboard, a button, a knob, a joystick, a switch, a dial, combinations thereof, or the like). The electronic device 100 can include a communication unit 126 for receiving application and operating system data, using Wi-Fi, Bluetooth, near field communication (NFC), cellular, and/or other wireless communication techniques. The electronic device 100 is not limited to the components and configuration of FIG. 1, but can include other or additional components (e.g., GPS sensors, directional sensors such a compass, physiological sensors, microphones, speakers, haptics engines, or the like) in multiple configurations as may be desired.

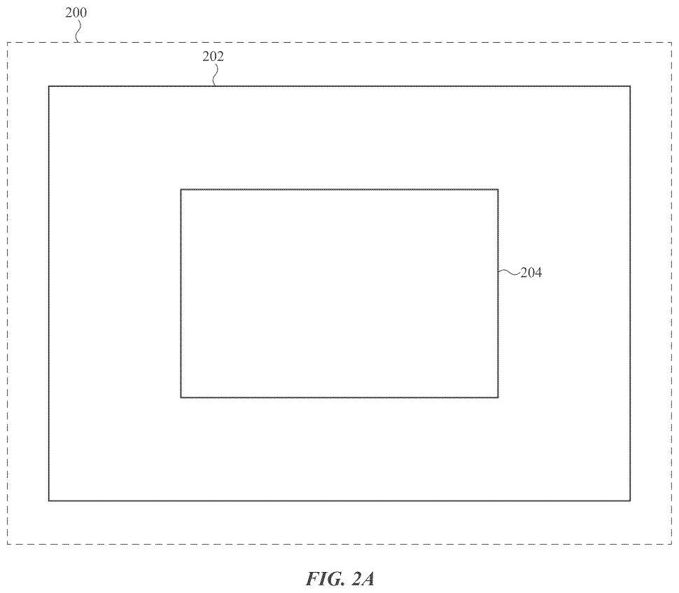

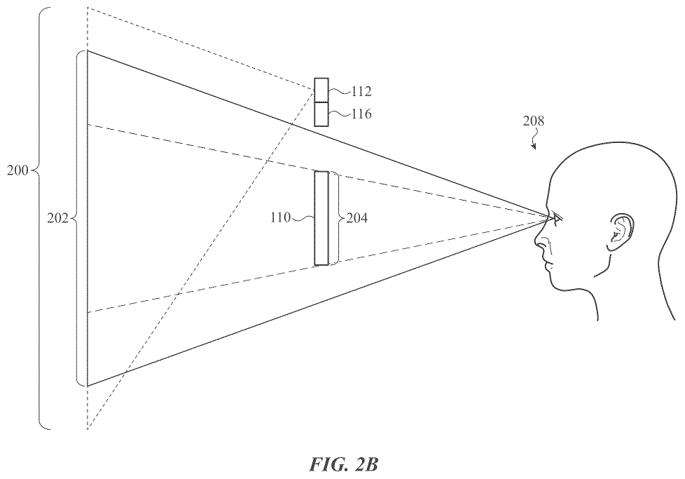

When a user is using an electronic device 100 with a display, an eye tracker, and a camera as part of an extended reality system, these components may cooperate to monitor related portions of a user's physical environment. For example, FIG. 2A is a diagram illustrating an example relationship between a camera field of view 200, a gaze field of view 202, and a display boundary 204 of the electronic device 100 discussed above with respect to FIG. 1. The camera field of view 200 defines an area over which images may be captured by at least one camera of the electronic device 100 (e.g., camera 112). Image data may be used from the camera field of view 200 to generate magnified content, as described in more detail herein.

The gaze field of view 202 may correspond to the area over which a gaze of the user can be tracked. In some embodiments, this may correspond with the area over which the location of the gaze of the user can be determined with a desired accuracy. The gaze field of view 202 may represent all or a subset of the user's full gaze range for a given head position. As shown, the gaze field of view 202 may be a subset of the camera field of view 200, however, this is not required. In some cases, the gaze field of view 202 may be the same size as or larger than the camera field of view 200.

The display boundary 204 may correspond to an area in which a magnified view, such as those described herein, may be viewed by a user of the electronic device 100 (e.g., when the electronic device 100 is worn as a head-mounted device). In some cases, the display boundary 204 may correspond to the physical boundaries of the display 110 of the electronic device 100. In other instances, the display boundary 204 may correspond to a subset of a display area of the display 110. In these instances, the display 110 may be capable of displaying a portion of the extended reality environment (e.g., virtual content, an indirect reproduction of the user's physical environment, and/or a modified representation of the user's physical environment) outside of the display boundary 204, but the electronic device 100 may only present a magnified view within the display area. This may allow an extended reality system to restrict a magnified view to a particular area, which may provide for an improved user experience.

In some instances, the display boundary 204 at least partially overlaps with the camera field of view 200 and the gaze field of view 202 As shown, the display boundary 204 may be smaller than both the camera field of view 200 and the gaze field of view 202. However, this is not required, and the display boundary 204 may be the same size or larger than the camera field of view 200 and/or the gaze field of view 202. The display 110 may be at least partially transparent, such that the physical environment is viewable through the display boundary 204, as well as through any surrounding portions of the display in instances where the display boundary 204 is smaller than the physical boundaries of the display 110. In this way, graphical elements (such as the magnified views described herein) can be overlaid on the physical environment within the display boundary 204.

In some instances, the electronic device 100 may also include an object detection field of view (not shown). The object detection field of view may correspond to the boundaries of the environment in which the electronic device 100 is able to perceive and/or identify objects. For example, the object detection field of view may correspond with the camera field of view 200, or a combination of the camera field of view and a corresponding field of view of one or more other sensors (e.g., one or more depth sensors 114). For example, a depth sensor 114 may have a wider field of view than the camera field of view 200, and the depth sensor 114 may be able to track an object outside of the camera field of view 200. In these instances, the object detection field of view may be larger than the camera field of view 200.

FIG. 2B shows the camera field of view 200, the gaze field of view 202, and the display boundary 204 as they relate to a user 208 of the electronic device 100. For context, the eye tracker 116, the display 110, and a camera 112 are also shown. As shown, the camera field of view 200 may correspond to a field of view of the camera 112. The gaze field of view 202 may correspond to the area in which the gaze of the user can be detected by the eye tracker 116. This may be limited based on constraints of the eye tracker 116, such as a location thereof, the capabilities thereof, or the like. In the example shown in FIG. 2B, the display boundary 204 corresponds to the location of the display 110 with respect to the user. While not shown, the display 110 may be supported by the frame or other supporting structure that positions the display 110 at a particular distance from the user 208 and at a particular location with respect to the user 208. This may determine the display boundary 204 as viewed by the user 208.

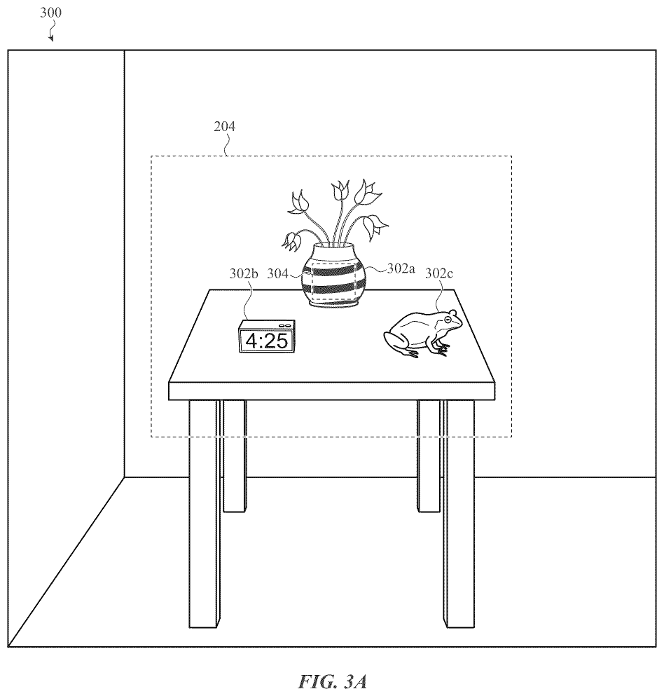

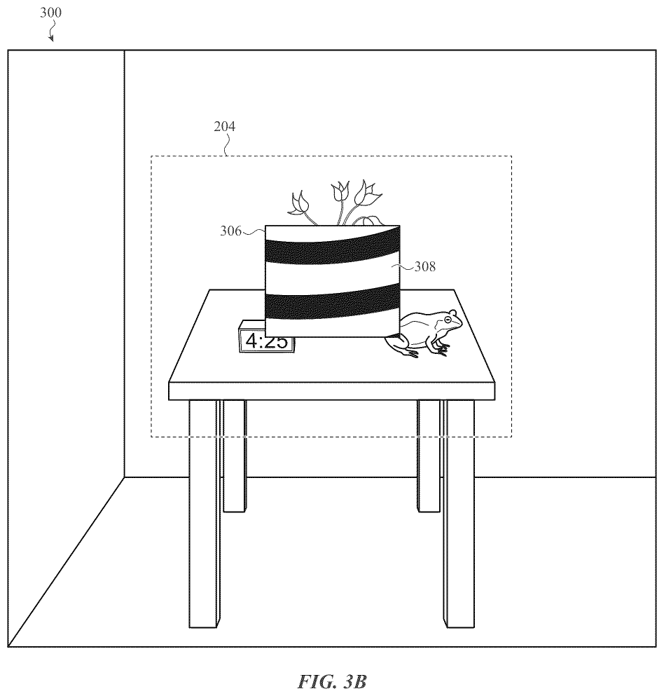

FIGS. 3A and 3B depict a scene 300 that may be viewed by a user (e.g., using the electronic device 100 of FIG. 1) as part of an extended reality environment. The scene 300 may represent a portion of the user's physical environment that is visible to the user at a given moment in time. Depending on the configuration of the electronic device 100, the user may be able to perceive part of their physical environment directly (e.g., outside of the boundaries of the display 110 and any frame or other supporting structure that holds the display 110). Additionally, the user may perceive part of their physical environment through the display 110, either as a direct reproduction (in the instance of a transparent or translucent display 110) or an indirect reproduction (e.g., as part of a passthrough mode).

In some instances, it may be desirable for a user to be able to see a magnified portion of the scene 300. This may allow a user to better visualize a region of the scene 300 without requiring the user to physically move (e.g., walk closer to an object of interest). For the purpose of discussion, the scene 300 is shown in FIG. 3A (as well as in other figures) as including a plurality of objects 302a-302c. Specifically, a first object 302a is depicted as a pot with flowers, a second object 302b is depicted as a clock, and a third object 302c is depicted as a frog. Each of the plurality of objects 302a-302c may be a real-world object or a virtual object. For example, the first object 302a may be a real-world pot with flowers. In these instances, depending on where the first object 302a is positioned within a gaze field of view 202 of the electronic device, the user may be able to directly view the first object 302a (e.g., through a transparent or translucent display or outside the boundary of a display 110 of the electronic device 100) or indirectly view the first object 302a (e.g., as an indirect representation of the object). In other variations, the first object 302a may be a virtual object (e.g., a simulated pot with flowers that is not actually present in the physical environment). Accordingly, in some instances it may be possible that a zoom reticle may present magnified content that includes magnified virtual content.

To present a magnified view, the electronic device 100 may receive a request to activate a zoom reticle. Depending on the configuration of the electronic device 100, the request may be received under some predetermined conditions (e.g., a software application running on the electronic device 100 may, with appropriate user permissions, automatically request that the electronic device 100 activate a zoom reticle when certain criteria are met) or when a user gives a command to activate the zoom reticle by interacting with the electronic device 100 (or another portion of the an extended reality system incorporating the electronic device 100). For example, a user may give a command by performing a predetermined action. The predetermined action may include performing a gesture, making a particular facial expression or eye movement, providing a manual input (e.g., pressing a designated button, interacting with a touch screen) to the electronic device 100 or an accessory device (e.g., a joystick, mouse, or the like) associated with the electronic device 100, giving a voice command, looking at a particular region of the gaze field of view 202, or the like.

After receiving a request to activate the zoom reticle, the electronic device 100 may select a target region 304 of the scene 300 that will be magnified as part of displaying the zoom reticle. In some instances, the target region 304 is selected from a portion of the gaze field of view 202. Because the magnified content may be derived from image data from a camera, the target region 304 may also define a corresponding region of the camera field of view 200. By selecting a region of the field of view 200 of the camera 112, the electronic device 100 will be able to capture one or more images (e.g., an image stream) of the physical environment corresponding to the target region 304. In some instances, the target region 304 may be a default region of the gaze field of view 202. In these instances, the default region of the gaze field of view 202 may be selected as the target region independently of the content of the scene 300 and independently of how the user is interacting with the scene 300. In other variations, the target region 304 may be dynamically selected based on the content of the scene 300 and/or how the user is interacting with the scene 300.

The electronic device 100 may also select a display location, which represents a portion of the display 110 of the electronic device 100 that will display the zoom reticle. When the zoom reticle is first activated, the electronic device 100 selects an initial display location. The electronic device 100 may select an initial display location in any suitable manner as described herein. In some instances, the electronic device 100 may select a default initial display location (e.g., that is selected independently of the content of the scene 300 and/or how the user is interacting with the scene 300). In other instances, the electronic device 100 may select an initial display location based on the content of the scene 300 and/or how the user is interacting with the scene 300, such as described in more detail below.

In some variations, the selected target region 304 may be linked with the selected display location, such that there is a predetermined relationship between the target region 304 and the display location. For example, in some variations it may be desirable for the zoom reticle to be at least partially positioned over the portion of the scene 300 that is being magnified. This may allow the user to look at the magnified portion of the scene 300 in the context of the surrounding areas of the scene 300. In these instances, the selection of the target region 304 may dictate the selection of the display position (or vice versa), and the selected target region 304 and display position will correspond to a common portion of the scene 300. Additionally, the relative position between the display location and the target region 304 may be adjusted to give a perspective of the magnified portion of the scene being presented at a particular depth relative to the zoom reticle.

In other variations, the electronic device 100 may opt to magnify a portion of the scene 300 that is within a field of view of the camera 112, but is outside of the display boundary 204. In some of these instances, it may be desirable to position the zoom reticle as close as possible to the target region 304 while still remaining within the display boundary 204. Accordingly, in these instances the display position may be selected using a position of the selected target region 304 (e.g., to minimize a distance between the two).

After selecting the target region 304 and the initial display location, the electronic device 100 will display a zoom reticle 306 at the initial display location of the display 110 of the electronic device 100, such as shown in FIG. 3B. The display zoom reticle 306 includes magnified content 308, that represents a magnified portion of the target region 304. Specifically, the magnified content 308 may be generated from image data captured by the camera 112 of the electronic device 100. In some instances, image data from the camera 112 may be digitally magnified (e.g., using a “digital zoom” operation). In these instances, image data from a portion of the camera's field of view (e.g., corresponding to the target region 304 of the scene) may be modified to generate an enlarged image. In some instances, the electronic device 100 may upscale the image data as part of a digital operation to account for loss of resolution that may occur in generating the enlarged image. Additionally or alternatively, the camera 112 may include optical zoom capabilities that may change the field of view of the camera 112 to at least partially magnify the images captured by the camera 112.

In some variations, the magnified content 308 may be updated over time as the scene 300 changes (e.g., as objects move within the scene 300 and/or the user reorients the electronic device 100 relative to the scene 300 by moving or looking around). For example, the image data used to form the magnified content 308 may be updated as subsequent images are captured by the camera 112. Specifically, the camera 112 may capture a stream of images, each of which is used to generate a different frame of magnified content 308. In other words, the zoom reticle 306 may present an image stream that represents a magnified portion of the scene 300 that is updated with changes in the scene 300. Similarly, the display location of the zoom reticle 306 may change from the initial display location over time. Additionally or alternatively, the location of the target region 304 relative to the gaze field of view 202 and camera field of view 200 may change over time to capture different portions of the gaze field of view. In other variations, the display location of the zoom reticle 306 and/or the target region 304 may remain fixed over time while the zoom reticle 306 is displayed.

As mentioned previously, in some variations it may be desirable to select an initial display location for the zoom reticle 306 based on the content of the scene 300 and/or the user's interaction with the scene. For example, in some variations of the extended reality systems described herein, location information about a user's gaze may be used to select an initial display location for the zoom reticle 306. Specifically, the location of a user's gaze within the gaze field of view 202 may be detected by the eye tracker 116. This information (also referred to herein as “location information”) about the user's gaze location may be collected and temporarily stored, and may be analyzed to select an initial display location for the zoom reticle 306. For example, the location information may be temporarily stored in a data buffer that stores location information for a predetermined amount of time (e.g., with new data replacing the oldest data in the buffer). In this way, a certain amount of a user's gaze history may be available at any given point in time.

The electronic device 100 may be configured to analyze a portion of a user's gaze history in order to select an initial display location for the zoom reticle 306. The user's gaze history may reflect a region of the gaze field of view 202 that the user wants to magnify using the zoom reticle 306. For example, if the user is looking at a particular object or region in a scene (e.g., the first object 302a in the scene 300 of FIGS. 3A and 3B) just prior to or while initiating a request to activate a zoom reticle 306, the electronic device 100 may identify that object or region as a region of interest. Images captured by the camera 112 may also be temporarily stored (e.g., in an image buffer), so that the electronic device 100 may associate the user's gaze history with the images captured by the camera 112, which may facilitate identifying the region of interest. The electronic device 100 selects the initial display location and/or the target region to be magnified based on the identified region of interest. For example, the target region 304 may be selected so that the zoom reticle 306 includes a magnified portion of the region of interest. Similarly, the initial display location may be selected such that the zoom reticle 306 is positioned near or partially overlapping the region of interest.

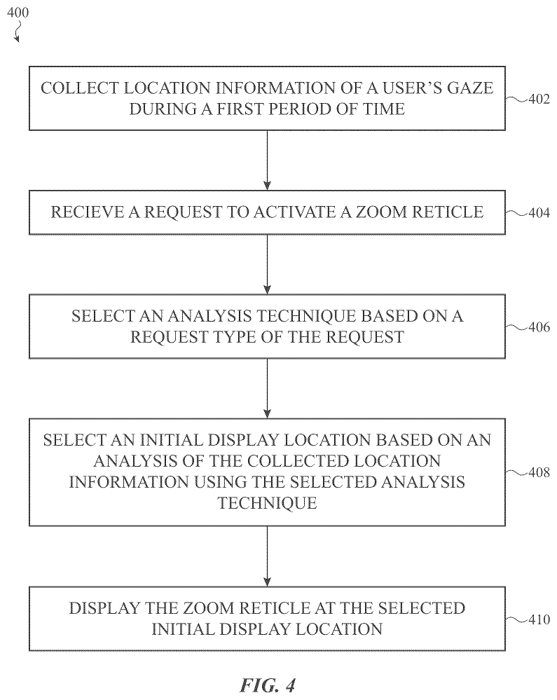

Accordingly, the gaze history of a user may be analyzed to select a region of interest in a scene. In some variations, the electronic device 100 may use different techniques for analyzing the user's gaze history depending on what type of request is used to activate the zoom reticle. For example, FIG. 4 shows a method 400 of selecting an initial display location of a zoom reticle based on the type of request that is used to activate the zoom reticle. The operations may be performed, for example, by the electronic device 100 discussed above with respect to FIGS. 1-3B.

At block 402, location information of a user's gaze may be collected during a first period of time. The location information may be detected, for example, by an eye tracker as discussed herein. Accordingly, the collected location information may represent the user's gaze history during the first period of time. At block 404, a request to activate a zoom reticle is received. The request to activate the zoom reticle may be received in any manner (e.g., automatically or command by a user) as described herein. Additionally, the request may be received at any point relative to the first period. For example, the request may be received at the end of or following the first period of time, such that the collected location information includes only location information that was collected prior to identification of the request. For example, the first period of time may represent a window of time immediately prior to the receipt of the request to activate the zoom reticle. In other instances, the request may be received during the first period of time, such that the collected location information includes information that was collected prior to and after the identification of the request.

The request to activate the zoom reticle may have a request type. Specifically, each request may be associated with a request type that is selected from a list of candidate request types. For example, when voice commands are used to request the activation of a zoom reticle, these voice commands may be associated with one or more voice command types. Similarly, a user may look at a particular region of a gaze field of view to request activation of a zoom reticle, and these requests may be associated with one or more gaze-based request types. There may request types associated with manual inputs, gestures, facial expressions, and so on.

Each request type may be associated with a corresponding analysis technique. Each analysis technique involves a set of operations that may be applied to the collected location information in order help select an initial display location for the zoom reticle. For example, depending on the analysis technique, the electronic device may select a certain subset of the location information, apply weights to particular portions of the location information, etc., in an attempt to determine where the user would want the zoom reticle to be positioned. In other words, each analysis technique may be applied to collected location information to identify a region of interest. The initial display location may be selected using the identified region of interest. In some variations, if a selected analysis technique is unable to identify a region of interest from collected location information, the electronic device may select a default initial display location.

As an example, whenever a voice command associated with a voice command type is used to request the activation of a zoom reticle, the electronic device may use a first analysis technique for selecting the initial display location. In these instances, a user may be most likely to be looking at a region of interest while giving the voice command. Accordingly, the first analysis technique may prioritize location information that was collected while the user was speaking. The first analysis technique may apply a greater weight to this location information, or may select a particular subset of data that includes this location information.

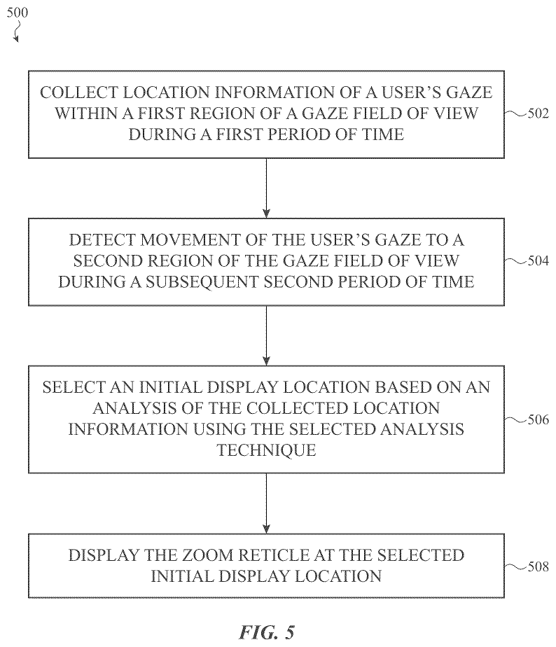

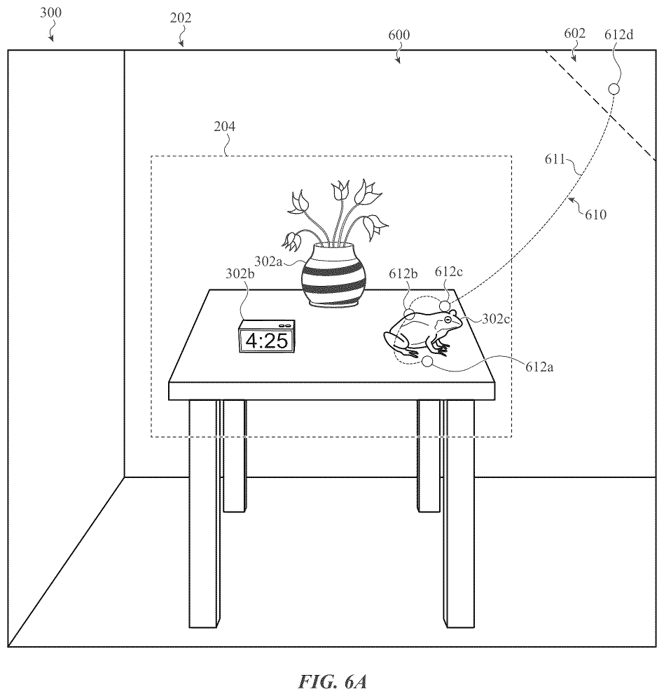

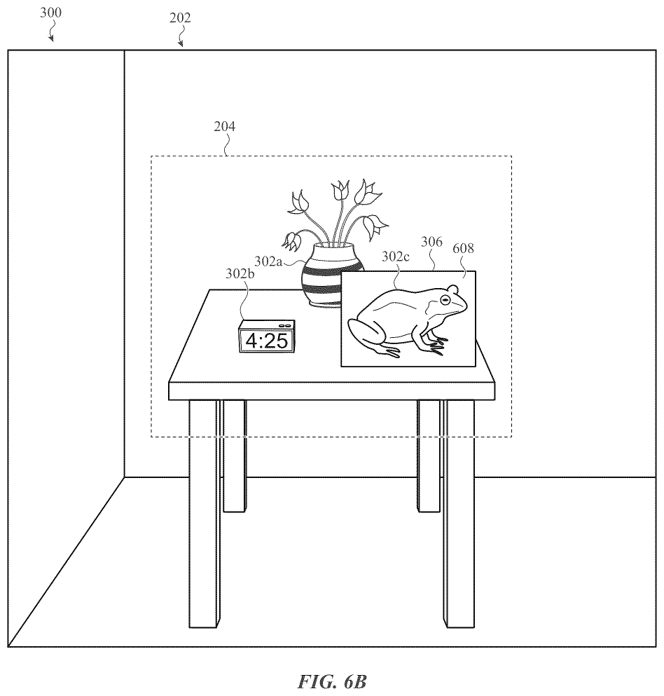

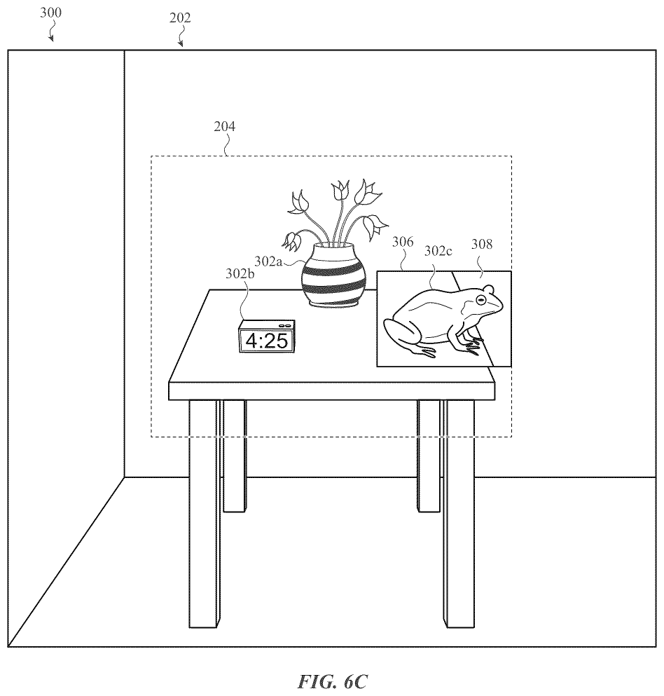

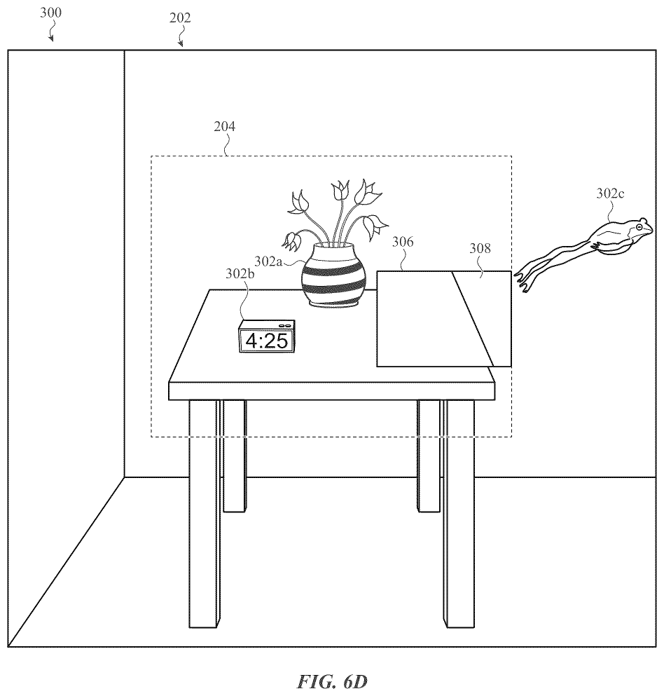

Conversely, when a user utilizes a gaze-based request type to activate a zoom reticle, the user may need to look away from a region of interest in order to initiate the request. Accordingly, a gaze-based request type may be associated with a second technique for selecting the initial display location. In these instances, the second technique may deemphasize location information that was collected while the user was initiating the request. An example of such an analysis technique is described herein with respect to FIGS. 5, 6A and 6B.

At block 406 an analysis technique is selected based on the request type. At block 408, an initial display location of a display of the electronic device is selected based on an analysis of the collected location information using the selected analysis technique. Specifically, some or all of the location information collected during the first period of time may be analyzed according to the selected analysis techniques. The electronic device may use this analysis as an input in selecting the initial display location. For example, if the analysis may identify that the user had been focusing on a region of interest, the electronic device may determine whether the region of interest is still present in the scene. Accordingly, the initial display location may be selected based on a current position of the region of interest within the gaze field of view. Accordingly, while the user may have initially been looking at a first portion of the gaze field of view, changes to the scene may result in the zoom reticle being displayed at a different position in the gaze field of view. At block 410, the zoom reticle is displayed at the selected display location, and includes a magnified portion of the gaze field of view.

In some instances, the region of interest is associated with an object that is present in the gaze field of view. Specifically, the selected analysis technique may be used to identify a target object in the gaze field of view. In these instances, a position of the target object (e.g., a current position of the target object) may be used to determine the initial display location. It should be appreciated that the target region of the gaze field of view may also be selected using the selected analysis technique. In instances where the selected analysis technique identifies a region of interest, the region of interest may be used in selecting the target region. For example, in some instances the target region may be selected such that at least a portion of the target object is magnified in the zoom reticle.

FIG. 5 shows an example of a method 500 of selecting an initial display location of a zoom reticle when a user's gaze is used to request the activation of the zoom reticle. The operations may be performed, for example, by the electronic device 100 discussed above with respect to FIGS. 1-3B. At block 502, location information of a user's gaze within a first region of a gaze field of view is collected during a first period of time. The location information may be collected in any suitable manner (e.g., using an eye tracker) as discussed herein. At block 504, movement of the user's gaze to a second region of the gaze field of view is detected during a second period of time that is subsequent to the first period of time. The second region may be different from the first region, and may represent a portion of the gaze field of view that a user may look at to initiate the request. In some variations, the request to activate the zoom reticle is considered to be received as soon as the user's gaze enters the second region. In other variations, the request to activate the zoom reticle is not considered to be received until one or more additional requirements are met (e.g., the user's gaze remains in the second region for a predetermined dwell time). It should be appreciated that the first and second periods of time of method 500 may represent different portions of the first period of time described with respect to method 400.

In response to determining that the user's gaze has moved to the second region (and any additional requirements are met), an initial display location of a display of the electronic device is selected at block 506 using the location information collected during the first period of time. At block 508, the zoom reticle is displayed at the selected display location, and includes a magnified portion of the gaze field of view.

FIGS. 6A and 6B illustrate aspects of method 500 in the context of the scene 300 of FIGS. 3A and 3B. Specifically, in FIG. 6A the portion of the scene 300 that is depicted represents the boundaries of the gaze field of view 202 of the electronic device 100. The gaze field of view 202 is divided into a first region 600 and a second region 602. The second region 602 represents an activation region of the gaze field of view 202 that is associated with a request to activate a zoom reticle. When the user's gaze moves into the second region 602 (and meets any other additional requirements as may be required), the electronic device 100 may determine that a user is requesting the activation of the zoom reticle. While only two regions are shown in FIG. 6A, in some instances the first region 600 may be further subdivided if there are other activation regions in the gaze field of view 202 that may be associated with other functions of the electronic device 100. Additionally, in some variations the second region 602 may be positioned outside of the display boundary 204, such as shown in FIG. 6A. In other variations the second region 602 may be positioned at least partially within the display boundary 204.

The electronic device 100 may track a user's gaze 610 within the gaze field of view 202, such as shown in FIG. 6A. Specifically, dashed line 611 represents movement of the user's gaze 610 whereas circles 612a-612d represent pauses during which the users gaze 610 remained at a fixed location within the gaze field of view 202. As depicted, the user's gaze 610 starts in the first region 600 of the gaze field of view 202 (e.g., during a first time period as discussed with respect to block 502 of method 500). During this time, the user's gaze 610 is largely focused on the third object 302c (e.g., the user's gaze 610 includes three pauses 612a-612c in close proximity to the third object 302c) before moving to the second region 602 during a second period of time.

Accordingly, when the user's gaze is in the second region 602 (e.g., after pause 612d), the electronic device 100 may receive the user's request to activate a zoom reticle. The electronic device 100 may utilize the location information of the user's gaze 610 that is collected during the first period of time to select an initial display location for the zoom reticle. Specifically, the electronic device 100 may use this gaze information to identify a region of interest in the scene 300, and may select the initial display location so that it corresponds to the region of interest. Because the presence of the user's gaze 610 within the second region 602 is intended to activate the zoom reticle (as opposed to the user looking at a region of interest), location information collected while the user's gaze 610 is in the second region may be disregarded for the purpose of calculating the display location. Similarly, motion within the first region 600 as the user's gaze 610 approaches the second region 602 may similarly be ignored or given a reduced weight, as this motion may be less indicative of the region of interest.

In some variations, selecting the initial display location includes detecting a target object in the gaze field of view. Specifically, the location information collected during the first period of time may be used to detect a region of interest that includes a target object. For example, analysis of the user's gaze 610 as shown in FIG. 3 may select the third object 302c as a target object. The electronic device 100 may select the initial display location using a position of the target object 302c in the gaze field of view 202.

In some examples, the electronic device may determine a current position of the target object in the gaze field of view 202. It may be possible, as the user's gaze 610 moves to the second region 602, that the target object may move within the scene 302 and/or electronic device 100 moves relative to the scene, such that the target object's position in the gaze field of view 202 changes. Accordingly, by determining a current position of the target object in the gaze field of view 202, the electronic device 100 may account for any such movement.

In some variations, the initial display position may be selected such that the zoom reticle at least partially overlaps the target object. For example, as shown in FIG. 6B, the zoom reticle 306 is positioned at a display location such that the zoom reticle 306 is positioned at least partially over the target object 302c. Additionally, a target region (not shown) may be selected that corresponds to a target object, such that the zoom reticle 306 includes magnified content 608 that depicts a magnified portion of the target object. For example, as shown in FIG. 6B the third object 302c is magnified within the zoom reticle 306.

If the target object is at least partially positioned within a display boundary (e.g., display boundary 204 shown in FIG. 6B), it may be possible for the zoom reticle 306 to be positioned to at least partially overlap the target object. If, however, a current position of the target object is outside of the display boundary 204, it may not be possible to position the zoom reticle 306 to overlap the target object. Accordingly, in some variations the initial display position may be selected as a default display position (e.g., centered within the display boundary) when a current position of the target object is outside of the display boundary. In other variations, the initial display boundary may be selected to minimize a distance between the zoom reticle and the target object when a current position of the target object is outside of the display boundary.

When the current position of the target object is outside of the display boundary, the target region of the gaze field of view (e.g., that is magnified within the zoom reticle 306) may, in some instances, be selected to correspond to the initial display location. In these instances, the zoom reticle 306 will overlap the portion of the scene 300 that it is magnifying, but may not magnify the target object. In other variations, the target region of the gaze field of view may be selected to correspond to a current position of the target object. In these instances, the target region may correspond to a portion of the gaze field of view 202 that is outside of the display boundary 204. Accordingly, the zoom reticle 306 may include a magnified portion of the target object, but may not be positioned to overlap the target object.

When the zoom reticle 306 is positioned at the initial display location, the zoom reticle 306 may remain fixed at that display location or may move to one or more updated positions within the display boundary 204. For example, when the initial display location is selected based on a target object (or another region of interest), the electronic device 100 may be configured to track movement of the target object in the gaze field of view. This movement may be the result of movement of the target object within the scene 300 (e.g., as the frog hops across the table) and/or movement of the electronic device 100 relative to the scene 300 (e.g., such that the gaze field of view overlaps a different portion of the scene 300). The electronic device 100 may select an updated display location using the detected motion, and may move the zoom reticle to the updated display location. For example, FIG. 6C shows the scene 300 of FIG. 6B after the third object 306c has moved to a new position within the gaze field of view 202. As shown, the electronic device 100 may update the position of the zoom reticle 306 to account for this movement, such that the third object 306c is still shown in the magnified content 308. In this way, the position of the zoom reticle 306 within the display boundary 204 may track movement of the target object within the gaze field of view 202.

In some instances, the position of the zoom reticle 306 can be updated to track movement of the target object only when the target object remains within a particular portion of the gaze field of view 202. For example, the position of the zoom reticle 306 is only updated when the target object remains within the gaze field of view 202. In these instances, it may be possible to track movement of the target object outside of the gaze field of view 202 (e.g., if the object detection field of view of the electronic device 100 is larger than the gaze field of view 202), but the electronic device 100 may not track this motion for the purpose of updating the zoom reticle 306. In some variations, the electronic device 100 may also be configured to move the zoom reticle 306 to a default display position if the target object leaves the gaze field of view 202. In other variations, the electronic device 100 may be configured to deactivate the zoom reticle 306 when the target object leaves the gaze field of view 202.

In other examples, the position of the zoom reticle 306 is only updated when the target object remains within the display boundary 204. For example, FIG. 6D shows an instance of the scene 300 in which the third object 302c has moved outside of the display boundary 204. In this example, the zoom reticle 360 may remain at the same display location as shown in FIG. 6C, even though the third object 302c (e.g., acting as the target object) has moved outside of the display boundary 204.

Additionally or alternatively, the target region of the gaze field of view may be updated with detected movement of a target object. For example, the electronic device may select the target region and the display location such that there is a fixed relationship between the two (e.g., the zoom reticle 306 is positioned over the portion of the gaze field of view 202 that is being magnified). In these instances, when the zoom reticle 306 is positioned over the target object, the magnified content 308 may also include a magnified portion of the target object. In some instances, the target region may be updated to continue at least partially overlapping the target object, even if the zoom reticle 306 is precluded from further movement by the display boundary 204. For example, in some variations, as the target object (e.g., the third object 302c) moves outside of the display boundary 204 as shown in FIG. 6D, the target region may be selected as a portion of the gaze field of view 202 that is positioned outside of the display boundary 204 to at least partially overlap the target object. In this way, although the zoom reticle 306 remains within the display boundary 204, the magnified content 308 may still show a magnified portion of the target object.

Additionally or alternatively, a magnification level associated with the zoom reticle 306 may change with motion of the target object relative to the gaze field of view 202. For example, when the zoom reticle 306 is initially displayed, the zoom reticle 306 may include magnified content 308 that is magnified at an initial magnification level. For example, a 2× magnification level would represent an instance in which the magnified portion of the scene (e.g., the target region) appears twice as large as compared to viewing the same portion of the scene without the zoom reticle 306. The initial magnification level may be a default magnification level (which may be modified based on user preferences), or may be selected based on a size or other characteristic of the target object. In some instances, the user may provide an input to the electronic device 100 to update the magnification level.

As the target object moves within the gaze field of view 202 (e.g., by movement of the target object relative to the scene 300 and/or the movement of the electronic device 100 relative to the scene 300), the target object may get closer to or farther from the electronic device 100. This may change how large the target object appears to the user (e.g., changes the size of the target object within the gaze field of view 202), and similarly how large the target object appears in the zoom reticle 306. Accordingly, the magnification level may be updated to account for these changes. For example, the magnification level may increase as the target object moves farther away from the electronic device 100, or may decrease as the target object moves closer to the electronic device 100. This may result in the target object appearing at the same size within the zoom reticle 306, even as the target object moves relative to the gaze field of view 202.

As mentioned previously, the magnified content 308 may be generated from image data captured by one or more cameras (e.g., the camera 112) of the electronic device 100. The image data may be processed in a manner that allows the magnified content 308 to be displayed according to a set of display properties. For example, it may be desirable for the magnified content 308 to be displayed with a certain brightness level, a contrast level, a transparency level, a magnification level, combinations thereof or the like. Accordingly, the set of display settings may include a corresponding setting for any or all of these properties, and the electronic device 100 may process the image data from the camera 112 to achieve the set of display settings.

For example, the set of display settings may include a contrast setting. In these instances, the contrast setting may define a desired contrast level for the magnified content 308 when it is displayed. The contrast of the image data may be adjusted as necessary (e.g., using known image processing techniques as will be readily understood by someone of ordinary skill in the art) to achieve this desired contrast level. Additionally or alternatively, the set of display properties may include a brightness setting (e.g., that sets a desired brightness level for the magnified content 308), a transparency level (e.g., that controls how much of the underlying scene 300 may be visible through the magnified content 308), a magnification level (e.g., that sets a magnification level of the magnified content 308), combinations thereof, or the like. Overall, the electronic device 100 may use these display settings to generate the magnified content 308 from a target region of the gaze field of view 202.

In some instances, it may be desirable to set different display settings based on the content of the scene that is being magnified. Different display settings may be useful in different contexts to better allow a user to perceive the magnified content. For example, when a zoom reticle is used to magnify text, it may be desirable to present that magnified content in a manner that promotes readability of the text. If the zoom reticle is used to magnify a particular type of object (e.g., a small animal), it may be desirable to present the magnified content in a manner that allows a user to see fine details of the object and/or deemphasizes any background content that is also visible in the zoom reticle. If the zoom reticle is used to magnify a piece of art, it may be desirable to present the magnified content in a manner that makes the art appear more vibrant (e.g., by adjusting the color saturation of the image data used to generate the magnified content).

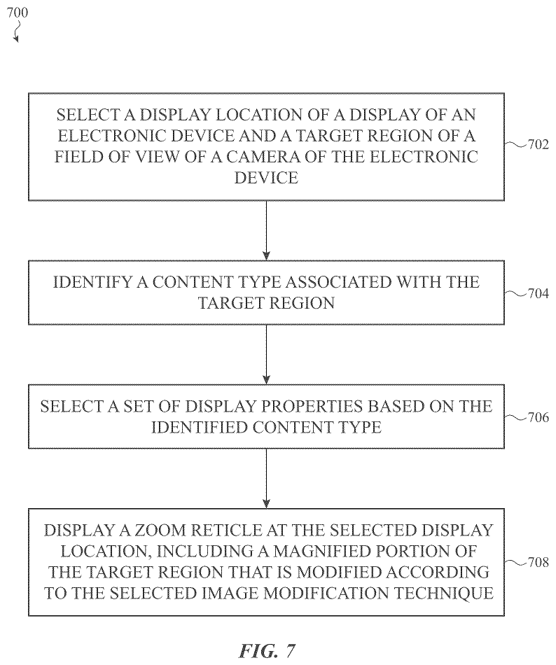

FIG. 7 shows an example of a method 700 of using an electronic device to display a zoom reticle, and that uses content-specific display properties to generate magnified content. The operations may be performed, for example, by the electronic device 100 discussed above with respect to FIGS. 1-3B. At block 702, the electronic device both i) selects a display location of a display of the electronic device and ii) selects a target region of a field of view of a camera of the electronic device. In some variations, block 702 may be performed in response to receiving a request to activate a zoom reticle, in which case the selected display location is an initial display location. The display location and the target region may be selected in any manner as described herein.

At block 704, a content type associated with the target region is identified. The content type acts as a classification of the subject matter that is present in the target region. In some variations, the content type is selected from a list of candidate content types. As an example, the electronic device may distinguish between target regions that contain text and those that do not contain text. In these instances, the list of candidate content types may include one or more text content types (e.g., in which text is identified in the target region) and one or more non-text content types (e.g., in which text is not identified in the target region). In some of these instances, the list of candidate content types may include multiple text content types (e.g., one or more text content types associated with labels, such as food labels or medication labels, one or more text content types associated with books or magazines, and so on). Additionally or alternatively, the list of candidate content types may include multiple non-text content types (e.g., one or more non-text content types associated with art, such as paintings, sculptures, or the like, one or more non-text content types associated with objects, such as animals, food, or the like, and so on).

The content type may be determined using any combination of cameras and other sensors of the electronic device (e.g., the cameras 112 and the depth sensors 114 of the electronic device 100). For example, one or more image processing techniques (e.g., optical character recognition techniques, image classification techniques, combinations thereof, or the like) may be used to select the content type. These image processing techniques may be applied to image and sensor data associated with the target region, and in some instances may also be applied to image and sensor data associated with regions surrounding the target region. These surrounding regions may provide additional context to what content is present in the target region.

At block 706, a set of display properties is selected based on the determined content type. For example, each content type of the list of candidate content types may be associated with a corresponding set of display properties. The display properties associated with a given content type may be fixed, or may be adjustable by a user. For example, the user may select particular display settings for certain content types (e.g., to apply a particular filter when a given content type, such as a non-text content type associated with art, is identified).

At block 708, the zoom reticle is displayed at the selected display location, and includes a magnified portion of the target region that is displayed according to the selected set of display properties. In some instances, the magnified portion of the target region fills the entire zoom reticle. In other instances, different portions of the zoom reticle may include magnified content that is displayed according to different sets of display properties. Specifically, the zoom reticle may be displayed such that the magnified portion of the target region (e.g., that is displayed according to the selected set of display properties) is displayed in a first area of the zoom reticle. A second region of the zoom reticle may also include an additional magnified portion of the target region. This additional magnified portion may be displayed according to a different set of display properties.

In some instances, the first area may be selected based on the determined content type. For example, if the content type is associated with a particular object (e.g., an animal), it may be desirable to display the object differently than any surrounding content. If the identified object does not completely fill the target region, the target region may be divided into a first portion corresponding to the object, and a second portion that does not correspond to the object (e.g., that instead corresponds to background content). The electronic device may select a first set of display properties that corresponds to the first area and a different second set of display properties that corresponds to the second area. Accordingly, the zoom reticle may display i) a first magnified portion (e.g., corresponding to the object) in a first area of the zoom reticle according to the first set of display properties, and ii) a second magnified portion (e.g., corresponding to the background content) in a second area of the zoom reticle according to the second set of display properties.

When the zoom reticle is actively being displayed, the set of display parameters may remain fixed or may be updated with changes in the scene. For example, if content of a scene changes (e.g., one or more objects moves within a scene and/or the electronic device is moved relative to the scene) the content type associated with the target region may change. If the electronic device determines that the content type associated with the target region has changed, the electronic device may select a new set of display properties based on the current content type, such that the zoom reticle includes a magnified portion of the target region that is displayed according to the newly selected set of display properties. In some instances, when the electronic device selects a new set of display properties, the electronic device may be configured to gradually transition between these properties, such that the user does not perceive an abrupt change in the processing used to generate the magnified content.

Overall, in these instances, for each frame that will be displayed within the zoom reticle, the electronic device may i) select a display location of the display and a region of a field of view of the camera, ii) determine a content type associated with the selected region, iii) select a set of display properties based on the determined content type, and iv) display a zoom reticle at the display location, where the zoom reticle includes a magnified portion of the target region that is displayed according to the selected set of display properties. As the determined content type changes between frames, so may the selected set of display properties.

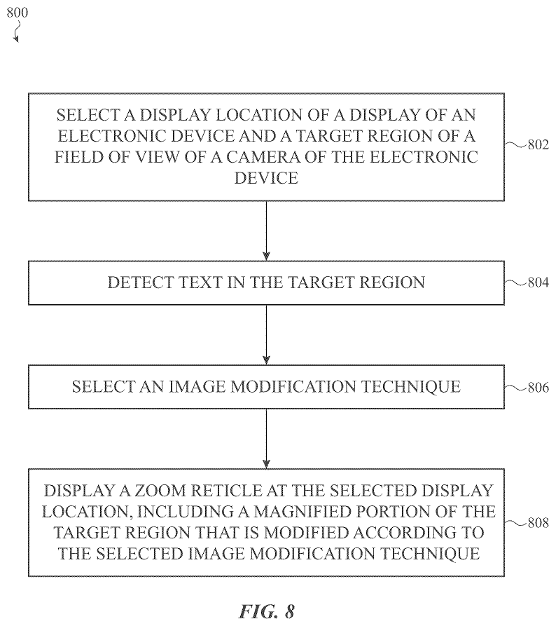

As mentioned previously, when magnifying text, it may be desirable to present text in a manner that makes it easier for the user to read this text. Accordingly, it may be desirable to apply one or more image modification techniques to image data that includes text. These image modification techniques may result in increased readability when magnified content is presented to the user. FIG. 8 depicts a method 800 of displaying a zoom reticle that includes magnified content, wherein the magnified content includes text that is modified according to an image modification technique. The operations may be performed, for example, by the electronic device 100 discussed above with respect to FIGS. 1-3B. At block 802, the electronic device both i) selects a display location of a display of the electronic device and ii) selects a target region of a field of view of a camera of the electronic device. In some variations, block 802 may be performed in response to receiving a request to activate a zoom reticle, in which case the selected display location is an initial display location. The display location and the target region may be selected in any manner as described herein.

At block 804, text is detected in the target region. The text may be detected in any suitable manner, such as using an optical character recognition technique. In response to detecting the text, an image modification technique may be selected at block 806. The image modification technique involves one or more image processing operations that are applied to the target region in order to modify the appearance of the target region when it is magnified. The image modification technique may be selected in any suitable manner. In some instances, the image modification technique may be selected based on the text itself and/or based on the content type associated with the text, such as described above. In these instances, the image modification technique may be selected such that the magnified content is displayed according to one or more display properties as discussed above.

In some variations, the image modification technique includes a contrast adjustment. Accordingly, the contrast adjustment may be applied to image data from the target region to adjust the contrast of the text. Additionally or alternatively, the image modification technique may include a brightness adjustment that may be applied to image data from the target region to adjust the brightness of the text. In other variations, the image modification technique includes replacing image data from the camera with synthetic image content. For example, if the detected text includes a particular word, the electronic device may generate virtual content that presents the same word. In these instances, the image data corresponding to the text may be replaced with virtual content. This may be beneficial in instances where the actual text in the scene, even after being magnified and adjusted using other image modification operations, may still be difficult for a user to read. Presenting synthetic image content may allow for precise control of how the text is presented to the user.

At block 808, a zoom reticle is displayed at the display location, and includes a magnified portion of the target region that is modified according to the selected image modification technique. In some variations, the magnified portion of the target region is presented at a magnification level that is selected based on the detected text. For example, it may be desirable to present text at a target character size. This target character size may be a default size, or may be set for a specific user based on their preferences and/or optical prescription. Accordingly, when text is detected in the target region, a character size may be determined for the detected text. This character size may represent the size of the detected text, and may represent the size of the smallest detected carrier, an average size of all of the detected text, or the like. The electronic device may select a magnification level based on the character size, such that the text will have the target character size when magnified in the zoom reticle.

In some variations, the image modification technique is only applied to a portion of the magnified content that is presented in the zoom reticle. Specifically, the zoom reticle may be displayed such that the magnified portion of the text (e.g., that is modified according to the selected image modification technique) is displayed in a first subregion of the zoom reticle. A second subregion of the zoom reticle may also include an additional magnified portion of the target region that is not modified according to the selected image modification technique. It should be appreciated that other image modification techniques may be applied to the second subregion such that the second subregion is presented according to a particular set of display properties as discussed above. In this way, areas within the target region that include text may be processed to facilitate readability of the text, whereas other areas in the target region may be processed based on the content that is present in those areas.

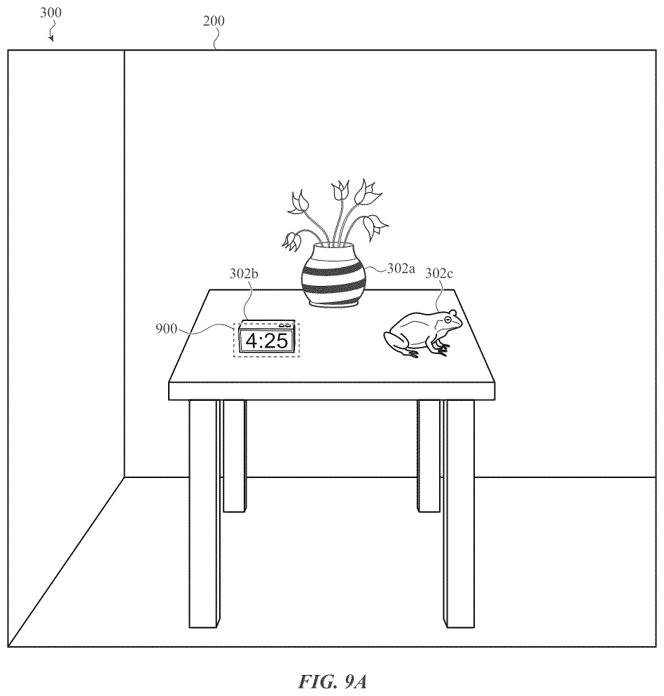

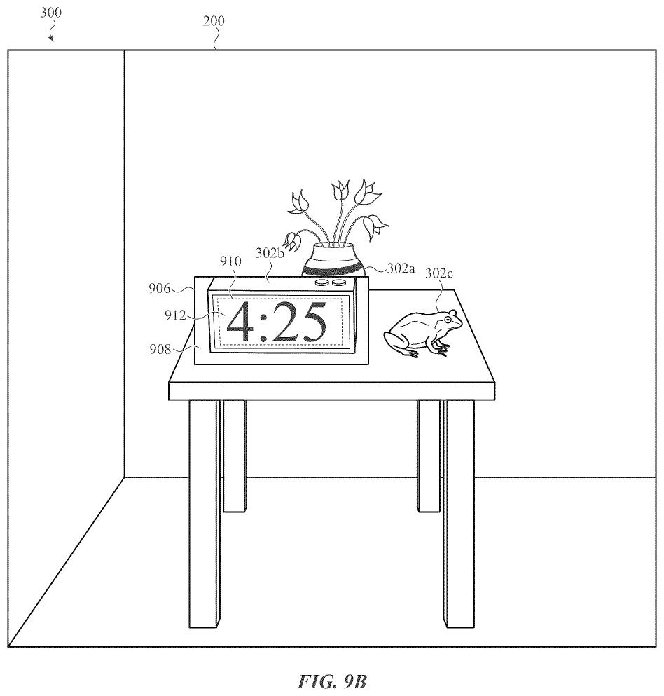

FIGS. 9A and 9B illustrate aspects of method 800 in the context of the scene 300 of FIGS. 3A and 3B. Specifically, in FIG. 9A the portion of the scene 300 that is depicted is encompassed within the camera field of view 200 of electronic device 100. As shown, a target region 900 is selected in the camera field of view 200 that includes text (which, in this example, includes the time displayed on the second object 302b). In FIG. 9B, a zoom reticle 906 is presented at a display location, and may include magnified content 908 that corresponds to the target region 900. At least a portion of the magnified content 908 (e.g., that corresponds to the detected text) may be modified according to a selected image modification technique as described with respect to the method of FIG. 8. In the example shown in FIG. 9B, a first subregion 910 of the magnified content 908 is replaced with synthetic image content. In these instances, the zoom reticle 906 may show the time currently being displayed on the second object 302b, but may change the font, color, styling, typographical emphasis and/or other properties of the text using the synthetic image content. While only the first subregion 910 is modified according to the selected image modification technique, in other instances the entire magnified content 908 may be modified according to the selected image modification technique.

In some instances, a magnified view as described herein may be used to help facilitate selection of a target input from an extended reality environment. As part of an extended reality environment, the electronic device may be configured to perform actions on behalf of the user that require a target input, such as a target object, selected from the extended reality environment. Before the action can be performed, the target input must be identified. However, it may not be clear which portion of the user's environment is intended to be the target input. Accordingly, it may be useful to clarify the user's intent. Accordingly, a magnified view may be used to clarify user intent, and in particular to identify one or more target inputs.

As an example, a user may initiate a request to the electronic device related to a target input in the physical environment. In particular, the request may be a voice command, such as the phrase “tell me about that,” where “that” refers to an object in the physical environment the user is looking at. In addition to requests for information, the request may be a command such as “turn this off,” a reminder prompt such as “next time I see this, remind me to put it away,” or any other type of request. As another example, a user may point to an object in the physical environment. As yet another example, a user may look at and/or focus on an object in the physical environment. The request may be a one-off request such as those discussed above, or a standing request performed every time some event occurs. For example, a user may request “every time I see this, remind me to call Bill.”

For some requests, the electronic device may be able to readily identify the target input based on the extended reality environment and/or a user's interaction with the extended reality environment. For example, in some instances the electronic device may be configured to identify one or more candidate objects at least partially located in the gaze region at or around the time of the request. In cases wherein there is only one candidate object in the gaze region, or when a context of the request or other information provides a clear indication of the target input, the request may be performed with respect to the target object. Following the example above, the electronic device may identify the target input as a plant the user is looking at, and provide information to the user about the plant (e.g., a size of the plant, a watering status of the plant, care instructions for the plant, information about the species of the plant, or the like). However, in many cases the gaze region may include multiple candidate objects, and it may not be clear which of the candidate objects is meant to be the target input.

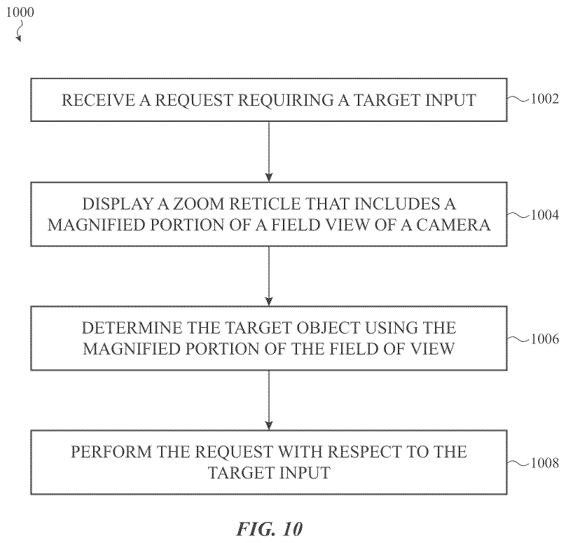

Accordingly, to facilitate selection of the target object from the set of candidate objects, a zoom reticle may be displayed at a display of the electronic device that may allow a user to select a target input. For example, FIG. 10 depicts a method 1000 of using a magnified view to help select a target input associated with a request. At block 1002, the electronic device receives a request requiring a target input in a field of view of a camera of the electronic device. The request may be received in any suitable manner. Depending on the configuration of the electronic device 100, the request may be received under some predetermined conditions (e.g., a software application running on the electronic device 100 may, with appropriate user permissions, automatically request that the electronic device 100 initiate an action that requires a target input) or when a user gives a command to initiate a request by interacting with the electronic device 100 (or another portion of the an extended reality system incorporating the electronic device 100). For example, a user may give a command by performing a predetermined action. The predetermined action may include giving a voice command, performing a gesture, making a particular facial expression or eye movement, providing a manual input (e.g., pressing a designated button, interacting with a touch screen) to the electronic device 100 or an accessory device (e.g., a joystick, mouse, or the like) associated with the electronic device 100, looking at a particular region of the gaze field of view 202, or the like.

The request may be associated with one or more actions that require the target input, and the electronic device may perform these actions using the target input once it is identified. For example, the request may be a request to provide information relating to the target input (e.g., a voice command such as “what is that?”), to set a reminder related to the target input, to control another device, such as a smart device, which is selected as the target input, or the like.

At block 1004, a zoom reticle is displayed at a display of the electronic device, and includes a magnified portion of the field of view of the camera. In some instances, the zoom reticle may be activated prior to receiving the request at block 1002, such that the zoom reticle is already being displayed when the request is received. In other instances, the zoom reticle is activated in response to receiving the request at block 1002. When the zoom reticle is activated in this manner, the zoom reticle may select an initial display location and an initial target region in any manner as described herein. For example, these parameters may be selected as default values or may be based on a user's gaze history prior to receiving the request. In some instances, the selection of the initial display location and the initial target region may depend, at least in part, on the type of request that is received. For example, some requests requiring a target input may result in a zoom reticle being initially positioned at a default display location, whereas other requests requiring a target input may be initially positioned at a display location that is selected based on a user's gaze history.

In some of these variations, the electronic device may attempt to identify the target input before activating the zoom reticle, and may only activate the zoom reticle if the electronic device is unable to identify the target input. If the electronic device is able to identify the target input before activating the zoom reticle, the electronic device may perform the request with respect to the target input without activating the zoom reticle.

At block 1006, the target input is determined using the magnified portion of the field of view that is presented in the zoom reticle. In some variations, this includes detecting, using the electronic device, a user interaction with the zoom reticle. The target input may be selected based on the detected user interaction. This allows the user to actively control the selection of the target input by interacting with the zoom reticle.

In some variations, the location of a user's gaze within the zoom reticle may be used to select the target input. For example, an eye tracker (e.g., eye tracker 116 of the electronic device 100) may determine a location of a user's gaze within a gaze field of view. While the zoom reticle is displayed, the eye tracker may determine a location of the user's gaze within the zoom reticle. This location may be determined using one or more selection criteria, such as when the user is looking at a particular location of the magnified content for a threshold amount of time. When the location of the user's gaze meets the selection criteria, the target input may be selected using that location. For example, if the location corresponds to an object in the scene, that object may be selected as the target input.

In some variations, an indicator may be displayed inside of the zoom reticle. The indicator, which may have any particular size or shape, may move within the zoom reticle to follow the user's gaze. In these instances, the user may move the indicator (e.g., by looking at the zoom reticle) until is positioned at a desired location within the zoom reticle. The user may perform one or more additional actions (e.g., holding their gaze at the desired location for a threshold amount of time, giving a voice command, providing a manual input to the electronic device, or the like) to confirm that the indicator is positioned at the desired location. Accordingly, this location may be used to select the target input as described above.

In other variations, the electronic device may select the target using a user gesture. For example, the user may point to a particular location within the zoom reticle, and this location may be used to select the target input. In still other variations, the user may move the electronic device to select the target input. Specifically, movement of the electronic device may be monitored to determine the target input. For example, the user may move the electronic device such that the target input (e.g., presented in the magnified content) is positioned at particular location in the zoom reticle (e.g., is centered in the zoom reticle). For example, an indicator may be displayed in the zoom reticle, and the user may move the electronic device until the indicator is positioned over a location of interest. The user may remain still (or with sufficiently low motion) for a threshold period of time, at which point the electronic device may determine the user has positioned the zoom reticle relative to the location of interest, and may use this location of interest to select the target input.

When the target input is determined, the request may be performed using the target input at block 1008. In some variations, the zoom reticle may be deactivated after the target input is determined, as it may no longer be necessary or desired for the zoom reticle to be present. In some instances, the zoom reticle may be deactivated in response to determining the target input only if the zoom reticle was initially activated in response to receiving the request. Accordingly, if the zoom reticle was already being displayed when the request was received, it may continue to be displayed after the target input is determined. In these instances, the zoom reticle may be deactivated under other circumstances (e.g., in response to a user command to deactivate the zoom reticle).

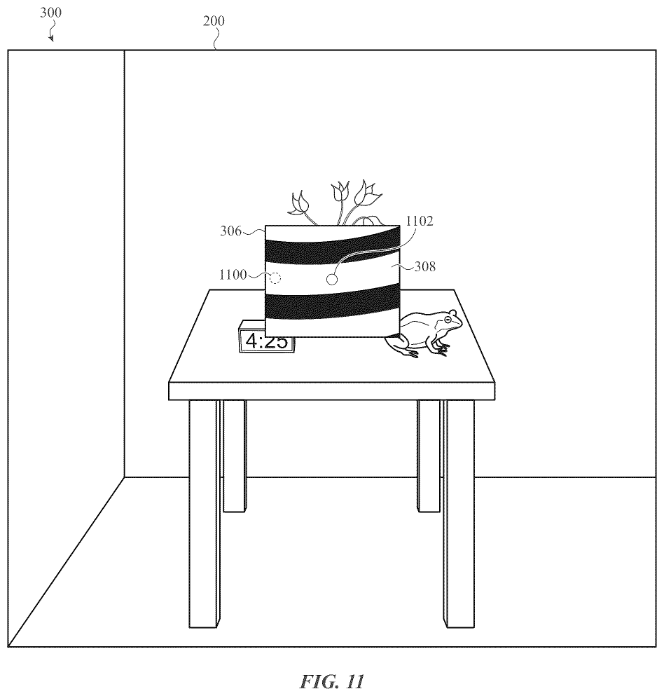

FIG. 1100 illustrate aspects of method 1000 in the context of the scene 300 of FIGS. 3A and 3B. Specifically, the portion of the scene 300 that is depicted represents the boundaries of the camera field of view 200 of the electronic device 100. The zoom reticle 306 is displayed in the extended reality environment, and includes magnified content 308, such as described previously. In response to receiving a request that requires a target input, the electronic device 100 may determine a location 1100, and may select the target input using the determined location 1100 (e.g., as an object corresponding to the determined location 1100). In some instances, the location 1100 may be determined using a user's gaze (e.g., if the user looks at the location 1100 for a threshold amount of time, if the user's gaze is used to move an indicator 1102 to the location 1100, or the like). In other instances, the location 1100 may be determined using a user gesture (e.g., the user points to the location 1100). In still other variations, the user may move the electronic device 100 such that the location 1100 is positioned in a particular area in the zoom reticle 306 (e.g., is positioned under the indicator 1102 shown in FIG. 11). Once the target input is selected, the electronic device 100 may perform the request using the selected target input.

In some variations of the devices and methods described herein, a user gesture may be used to change one or more aspects of the zoom reticle. For example, in some variations the electronic device 100 may be configured to detect the performance of a user gesture (or a portion thereof) while the electronic device 100 is actively displaying a zoom reticle. The electronic device 100 may, in response to detecting the user gesture while the electronic device 100 is displaying the zoom reticle, change one or more aspects of the zoom reticle.

In some variations, the electronic device 100 may change a magnification level associated with the zoom reticle in response to detecting the user gesture. In one example, one or more pinch gestures may be used to change a magnification level of the zoom reticle. For example, a pinch open gesture (e.g., in which a user spreads two fingers apart) may be used to increase the magnification level of the zoom reticle. When the electronic device 100 detects that that the user has performed a pinch open gesture, the electronic device 100 may increase the magnification level of the zoom reticle. In some of these variations, the electronic device 100 may increase the magnification level by a predetermined amount each time that the user performs the pinch open gesture (e.g., up to a maximum magnification level). In other variations, the electronic device 100 may increase the magnification level by an amount that depends on a magnitude of the pinch open gesture. In other words, the amount of the increase in the magnification level may depend on how much the user spreads apart their fingers while performing the pinch open gesture.

Conversely, a pinch closed gesture (e.g., in which a user brings two fingers closer together) may be used to decrease the magnification level of the zoom reticle. When the electronic device 100 detects that that the user has performed a pinch closed gesture, the electronic device 100 may decrease the magnification level of the zoom reticle. In some of these variations, the electronic device 100 may decrease the magnification level by a predetermined amount each time that the user performs the pinch closed gesture (e.g., down to a minimum magnification level). In other variations, the electronic device 100 may decrease the magnification level by an amount that depends on a magnitude of the pinch closed gesture. In these instances, the amount of the decrease in the magnification level may depend on how close the user brings their fingers to touching.

Additionally or alternatively, the electronic device may change a size of the zoom reticle in response to detecting a user gesture. In some variations, different user gestures may be used to change different aspects of the zoom reticle. For example, the electronic device 100 may change a magnification level associated with the zoom reticle in response to the electronic device 100 detecting that the user has performed a first gesture, and the electronic device 100 may change a size of the zoom reticle in response to the electronic device 100 detecting that the user has performed a second gesture.

In some variations, different instances of the same user gesture may be used to activate the zoom reticle and to change an aspect of the zoom reticle. For example, the electronic device 100 may utilize different instances of a first gesture (e.g., a pinch open gesture) to activate the zoom reticle and to change an aspect of the zoom reticle. If the electronic device 100 detects that the user has performed an instance of the first gesture while the zoom reticle is not being displayed, the electronic device 100 may activate the zoom reticle. Conversely, if the electronic device 100 detects that the user has performed an instance of the first gesture while the zoom reticle is being displayed, the electronic device 100 may change an aspect of the zoom reticle (e.g., increase a magnification level associated with the zoom reticle, increase a size of the zoom reticle, or the like).

Additionally or alternatively, the same instance of a user gesture may be used to both activate the zoom reticle and to change an aspect of the zoom reticle. In these instances, the electronic device 100 may activate a zoom reticle in response to detecting a first portion of a user gesture, and may change an aspect of the zoom reticle in response to detecting a second portion of the user gesture. Using a pinch open gesture as an example, the electronic device 100 may be configured to activate a zoom reticle in response to determining that the user has moved their fingers apart by a threshold amount. If the user continues to spread apart their fingers beyond the threshold amount (e.g., as part of the same pinch open gesture), the electronic device 100 may change an aspect of the zoom reticle (e.g., increase a magnification level of the zoom reticle).

In some variations, different instances of the same user gesture may be used to change an aspect of the zoom reticle and to deactivate the zoom reticle. For example, the electronic device 100 may utilize different instances of a second gesture (e.g., a pinch closed gesture) to change an aspect of the zoom reticle and to deactivate the zoom reticle. For example, if the electronic device 100 detects that the user has performed an instance of the second gesture while the zoom reticle is being displayed, the electronic device 100 may change an aspect of the zoom reticle (e.g., decrease a magnification level associated with the zoom reticle, decrease a size of the zoom reticle, or the like). If the aspect of the zoom reticle reaches a predetermined state (e.g., a minimum magnification level associated with the zoom reticle, a minimum size of the zoom reticle) and the electronic device 100 detects an additional instance of the second gesture, the electronic device 100 may deactivate the zoom reticle.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A method of operating an electronic device, comprising:
collecting, during a first period of time, location information of a gaze of a user within a first region of a gaze field of view;
detecting, during a second period of time subsequent to the first period of time, movement of the gaze of the user to a second region of the gaze field of view;
in response to detecting the movement of the gaze of the user to the second region, selecting a display location of a display of the electronic device, wherein the display location is selected using the location information collected during the first period of time; and
displaying a zoom reticle at the display location, wherein the zoom reticle includes a magnified portion of the gaze field of view.

2. The method of claim 1, wherein selecting the display location comprises:
detecting a target object in the gaze field of view using the location information collected during the first period of time; and
selecting the display location using a position of the target object in the gaze field of view.

3. The method of claim 2, comprising:
detecting motion of the target object in the gaze field of view.

4. The method of claim 3, comprising:
selecting an updated display location of the display using the detected motion of the target object; and
moving the zoom reticle to the updated display location.

5. The method of claim 3, comprising:
changing a magnification level of the zoom reticle using the detected motion of the target object.

6. The method of claim 1, wherein:
the display has a display area that is positioned to partially overlap the gaze field of view; and
the display location is selected such that the zoom reticle is positioned within the display area.

7. The method of claim 6, wherein:
the second region of the gaze field of view is positioned outside of the display area.

8. The method of claim 6, wherein selecting the display location comprises:
detecting a target object in the gaze field of view using the location information detected during the first period of time, wherein the target object is positioned outside of the display area; and
selecting the display location using a position of the target object in the gaze field of view.

9. An electronic device, comprising:
an eye tracker configured to detect a gaze of a user within a gaze field of view;
a display;
a processor operably coupled to the eye tracker and the display, the processor configured to:
collect, during a first period of time, location information of the gaze of the user within a first region of the gaze field of view;
detect, during a second period of time subsequent to the first period of time, movement of the gaze of the user to a second region of the gaze field of view;
in response to detecting the movement of the gaze of the user to the second region, select a display location of the display of the electronic device, wherein the display location is selected using the location information collected during the first period of time; and
display a zoom reticle at the display location, wherein the zoom reticle includes a magnified portion of the gaze field of view.

10. The electronic device of claim 9, comprising:
a camera having an imaging field of view that at least partially overlaps the gaze field of view.

11. The electronic device of claim, wherein selecting the display location comprises:
detecting a target object in the gaze field of view using the location information detected during the first period of time; and
selecting the display location using a position of the target object in the gaze field of view.

12. The electronic device of claim 11, wherein the processor is configured to:
detect motion of the target object in the gaze field of view.

13. The electronic device of claim 12, wherein the processor is configured to:
select an updated display location of the display using the detected motion of the target object; and
move the zoom reticle to the updated display location.

14. The electronic device of claim 12, wherein the processor is configured to:
change a magnification level of the zoom reticle using the detected motion of the target object.

15. The electronic device of claim 9, wherein:
the display has a display area that is positioned to partially overlap the gaze field of view; and
the display location is selected such that the zoom reticle is positioned within the display area.

16. The electronic device of claim 15, wherein:
the second region of the gaze field of view is positioned outside of the display area.

17. The electronic device of claim 15, wherein selecting the display location comprises:
detecting a target object in the gaze field of view using the location information collected during the first period of time, wherein the target object is positioned outside of the display area; and
selecting the display location using a position of the target object in the gaze field of view.

18. A method of operating an electronic device, comprising:
collecting, during a first period of time, location information of a gaze of a user within a gaze field of view;
receiving a request to activate a zoom reticle, the request having a request type; and
in response to receiving the request:
selecting an analysis technique based on the request type;
selecting a display location of a display of the electronic device, wherein the display location is selected based on an analysis of the collected information using the selected analysis technique; and
displaying a zoom reticle at the selected display location, wherein the zoom reticle includes a magnified portion of the gaze field of view.

19. The method of claim 18, wherein:
the request type is selected from a list of candidate request types that comprises a voice command type.

20. The method of claim 19, wherein the list of candidate request types comprises a gaze-based request type.
